(19) United States
(12) Patent Application Publication
(10) Pub. No.: US 2021/0305592 A1
(43) Pub. Date: Sep. 30, 2021

(54) JOINT STRUCTURE AND FUEL CELL SEPARATOR

(71) Applicant: HONDA MOTOR CO., LTD., Tokyo (JP)

(72) Inventors: Ryo UOZUMI, Tochigi (JP); Takashi KATO, Tochigi (JP); Kei MATSUMOTO, Tochigi (JP)

(21) Appl. No.: 17/207,735

(22) Filed: Mar. 21, 2021

(30) Foreign Application Priority Data
Mar. 26, 2020 (JP) 2020-056096

(51) Int. Cl. H01M 8/0267; H01M 8/0254; H01M 8/242

(52) U.S. Cl. CPC H01M 8/0267; H01M 8/242; H01M 8/0254

(57) ABSTRACT

The invention relates to a joint structure including a continuous joined section that joins together a pair of thin plates layered on each other so as to seal a space between the pair of the thin plates surrounded by the joined section, in which the joined section includes at least one continuous joining line which intersects plural times, and a plurality of spatial areas surrounded by two adjacent intersections of the joining line and the joining line connecting the two intersections.

This application is based on and claims the benefit of priority from Japanese Patent Application No. 2020-056096, filed on 26 Mar. 2020, the content of which is incorporated herein by reference.

### BACKGROUND OF THE INVENTION

### Field of the Invention

The present invention relates to a joint structure and a fuel cell separator.

### Related Art

Conventionally, a joint structure for joining together two thin plates along entire their outer peripheries to seal an inside space between the two thin plates surrounded by the joined section has been known. Patent Document 1, for example, discloses an art of joining together outer peripheries of two metal separators along two linear peripheral joining lines (weld beads) in bipolar-type metal separators for fuel cell.

Patent Document 1: Japanese Unexamined Patent Application, Publication No. 2019-71252

### SUMMARY OF THE INVENTION

The above-described prior art provides a joint structure with double joining line. According to this prior art, if a joining failure occurs in any of the joining lines on the inner periphery and outer periphery, leakage from inside to outside is blocked by the other joining line. However, if a joining failure occurs in each of the joining lines, leakage occurs. Thus, a joint structure having a lower probability of leakage occurrence has been demanded.

The present invention has been achieved in view of the above-described circumstances and an object of the invention is to provide a joint structure capable of reducing the probability of leakage compared to the prior art.

(1) A first aspect of the present invention relates to a joint structure including a continuous joined section that joins together a pair of thin plates layered on each other so as to seal a space between the pair of the thin plates surrounded by the joined section. The joined section includes at least one continuous joining line that intersects plural times, and a plurality of spatial areas surrounded by two adjacent intersections of the joining line and the joining lines connecting the two intersections.

According to the first aspect (1) above, each of the plurality of spatial areas has a structure sealed by the joining lines on the inner periphery and the outer periphery. Consequently, no leakage occurs in the entire range of the joined section unless joining failure occurs in the joining line on the inner periphery and joining line on the outer periphery which form a single spatial area, at the same time. As a result, probability of leakage in the joined section may be reduced compared to the prior art.

(2) A second aspect of the present invention relates to the joint structure described in the first aspect (1), in which two of the joining lines extend while intersecting each other at a predetermined interval.

(3) A third aspect of the present invention relates to the joint structure described in the second aspect (2), in which the joining line is formed in a wavy shape.

According to the second (2) and third (3) aspects above, the plurality of spatial areas can be formed easily and securely with the two joining lines.

(4) A fourth aspect of the present invention relates to the joint structure described in the first aspect (1), in which one of the joining lines extends with a plurality of loops formed by overlapping.

According to the fourth aspect (4) above, the plurality of spatial areas may be formed effectively because the joining line is single.

(5) A fifth aspect of the present invention relates to the joint structure described in any one of the first (1) to fourth (4) aspects, in which the joined section is provided on the outer periphery of the pair of the thin plates.

According to the fifth aspect (5) above, leakage may be suppressed effectively by applying the invention to the joined section on the outer periphery in order to reduce the probability of leakage.

(6) A sixth aspect of the present invention relates to a fuel cell separator which is layered onto a membrane electrode assembly, the fuel cell separator including a first separator of a thin plate and a second separator of a thin plate to be layered onto the first separator and joined together, the first separator and the second separator being joined together by the joint structure described in the first (1) to fifth (5) aspects.

According to the sixth aspect (6) above, the joint structure of the fuel cell separator having the first and second separators to be joined together may reduce the probability of leakage.

The present invention may provide a joint structure that allows the probability of leakage to be reduced as compared to the prior art and a fuel cell separator having such a joint structure.

### BRIEF DESCRIPTION OF THE DRAWINGS

FIG. 1 is an exploded perspective view showing a power generation cell of a fuel cell having a separator to which a joint structure according to an embodiment of the present invention is applied;

FIG. 2 is a partial longitudinal sectional view showing a layered structure of the power generation cell, taken along a line II-II in FIG. 1;

FIG. 3 is a plan view showing the above-described separator;

FIG. 4 is an enlarged view of a section indicated by IV in FIG. 3;

FIG. 5 is a view showing a modification of the joining line;

FIG. 6 is a view showing another modification of the joining line;

FIG. 7 is a view showing an example of forming the joining line shown in FIG. 6 by means of laser weld; and

FIG. 8 is a diagram for explaining probability of leakage from the joining line compared to the prior art.

### DETAILED DESCRIPTION OF THE INVENTION

Hereinafter, an embodiment in which the present invention is applied to a separator of a fuel cell stack will be described with reference to drawings.

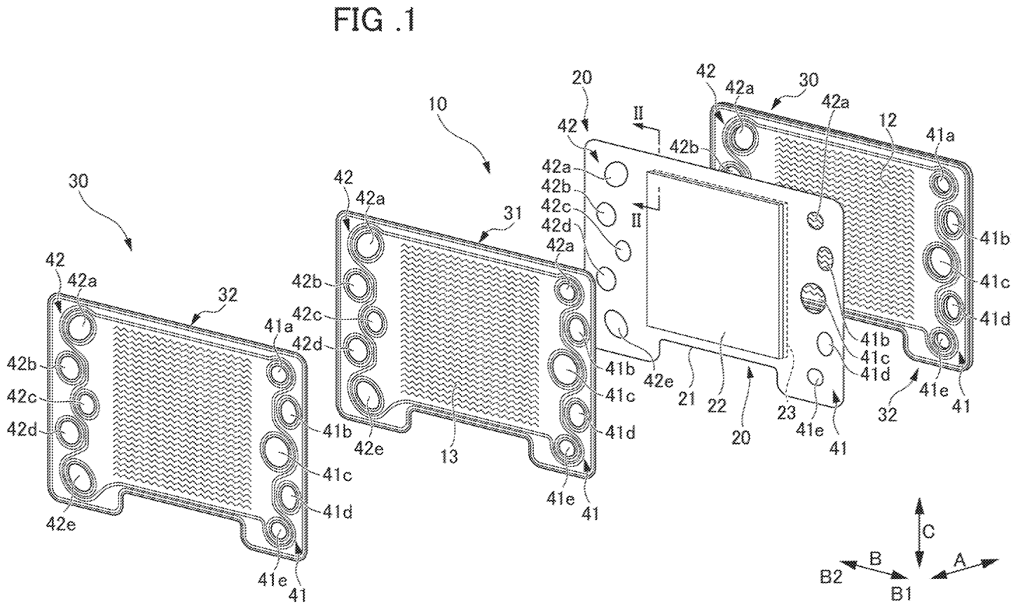

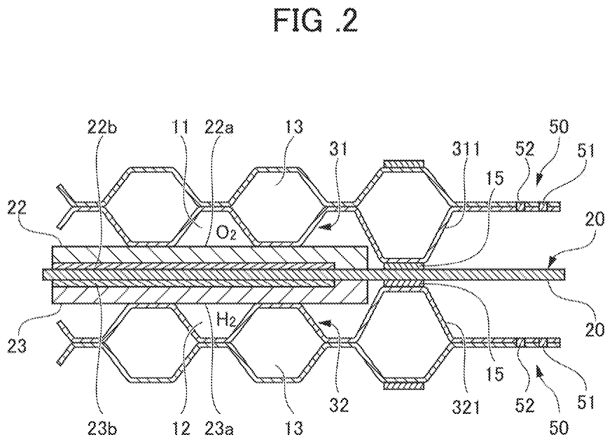

FIG. 1 is an exploded perspective view of a power generation cell 10 which constitutes a single unit of the fuel cell, and FIG. 2 is a view showing a layered structure of the power generation cell 10, taken along the line II-II.

As shown in FIG. 1 and FIG. 2, the power generation cell 10 includes a membrane electrode assembly 20 and a joining separator 30 as a fuel cell separator which sandwiches the membrane electrode assembly 20. Layering and joining together a plurality of power generation cells 10 in a horizontal direction indicated by an arrow A or a gravity direction indicated by an arrow C in FIG. 1, for example, constitutes a fuel cell stack (not shown). Although the fuel cell stack in which the power generation cells 10 according to the present embodiment are layered on one another is used as a vehicle mounted fuel cell stack for a fuel cell electric vehicle, for example, the application thereof is not restricted to this example.

As shown in FIG. 2, the membrane electrode assembly 20 includes an electrolyte membrane 21, a cathode electrode 22 layered on one side face of the electrolyte membrane 21 and an anode electrode 23 layered on the other side face of the electrolyte membrane 21.

The electrolyte membrane 21 is a rectangular solid polymer electrolyte membrane (cation membrane) in which thin film of perfluorosulfonic acid, for example, is impregnated with water.

The cathode electrode 22 and the anode electrode 23 include gas diffusion layers 22a, 23a made of rectangular carbon paper and catalyst layers 22b, 23b formed by coating the gas diffusion layers 22a, 23a with porous carbon particles having a surface carrying platinum alloy. The cathode electrode 22 and the anode electrode 23 are layered onto the electrolyte membrane 21 so that the gas diffusion layers 22a, 23a face outward to keep the catalyst layers 22b, 23b in contact with the electrolyte membrane 21, respectively.

The joining separator 30 includes a first rectangular separator 31 disposed on one of both sides of the membrane electrode assembly 20 and a second rectangular separator 32 disposed on the other side of the membrane electrode assembly 20. The first separator 31 and the second separator 32 indicate an example of the thin plate. In the layered power generation cell 10, the first separator 31 disposed on one side of an adjacent power generation cell 10 and the second separator 32 disposed on the other side are joined together by the joint structure according to the present embodiment.

The first separator 31 and the second separator 32 are composed of a metal thin plate, such as steel plate, stainless steel plate, aluminum plate, or aluminum alloy plate. The first separator 31 and the second separator 32 are manufactured by pressing such a metal plate into a wavy shape. Although the thickness of each of the first separator 31 and the second separator 32 is around 0.5 mm for example, the thickness is not restricted to values in this range. Preferably, the surfaces of the first separator 31 and the second separator 32 are treated with an anticorrosive.

As shown in FIG. 2, the first separator 31 is in contact with the gas diffusion layer 22a of the cathode electrode 22 and the second separator 32 is in contact with the gas diffusion layer 23a of the anode electrode 23. The power generation cell 10 contains a plurality of oxidant flow channels 11 between the first separator 31 and cathode electrode 22, and a plurality of fuel gas flow channels 12 between the second separator 32 and anode electrode 23. Further, the power generation cell 10 contains a plurality of refrigerant flow channels 13 for circulating refrigerant such as cooling water between the first separator 31 and the second separator 32 joined together.

As shown in FIG. 2, the first separator 31 has a first projecting section 311 for sealing the oxidant gas flow channel 11 on its outer periphery, and the second separator 32 has a second projecting section 321 for sealing the fuel gas flow channel 12 on its outer periphery. The projecting sections 311, 321 are located outside the cathode electrode 22 and anode electrode 23 of the membrane electrode assembly 20 and projected toward the electrolyte membrane 21 such that they oppose each other. Mutually opposing tips of the first projecting section 311 and the second projecting section 321 press and hold the electrolyte membrane 21 across a seal 15 made of resin, which is placed between each of the tips and the electrolyte membrane 21. Consequently, leakage of oxidant gas and fuel gas outward is prevented.

As shown in FIG. 1, the power generation cell 10 has a first communication hole group 41 and a second communication hole group 42 each composed of a plurality of holes communicating with each other in a layer direction (direction indicated with an arrow A), on both ends in the length direction in FIG. 1 or on an end on a side B1 and an end on a side B2 in a direction indicated with an arrow B.

The first communication hole group 41 contains five communication holes 41a, 41b, 41c, 41d, and 41e each composed of three holes as a group, each formed in the first separator 31, the second separator 32 and the electrolyte membrane 21 of the membrane electrode assembly 20, the same communication holes in the same group communicating with each other. The second communication hole group 42 contains five communication holes 42a, 42b, 42c, 42d, and 42e each composed of three holes as a group, formed in the first separator 31, the second separator 32 and the electrolyte membrane 21 of the membrane electrode assembly 20, the same communication holes in the same group communicating with each other. The communication holes 41a-41e of the first communication hole group 41 and the communication holes 42a-42e of the second communication hole group 42 are arranged substantially along a C direction.

The communication holes 41a-41e and the communication holes 42a-42e formed in the first separator 31, the second separator 32 and the electrolyte membrane 21 of the membrane electrode assembly 20 are classified appropriately to oxidant gas intake communication hole and outlet communication hole which communicate with the oxidant gas flow channel 11, fuel gas intake communication hole and outlet communication hole which communicate with the fuel gas flow channel 12, and refrigerant intake communication hole and outlet communication hole which communicate with the refrigerant flow channel 13, and function in such a manner.

A sealing section (not shown) which prevents each reaction gas (oxidant gas and fuel gas) and refrigerant from mixing with each other or leaking is provided at proper positions around the respective communication holes 41a-41e, 42a-42e on opposing surfaces of the first separator 31 and the second separator 32. The sealing section may be formed by means such as laser welding or brazing.

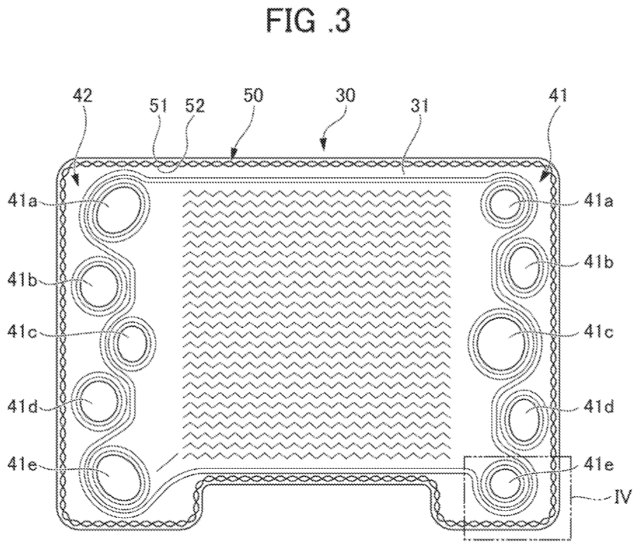

As shown in FIG. 2 and FIG. 3, the first separator 31 and the second separator 32 of the joining separator 30 are joined by the joined section 50 which constitutes the joint structure according to the present embodiment. Hereinafter, the joint structure of the present invention will be described.

According to the joint structure of the embodiment, the first separator 31 and the second separator 32 of a pair of thin plates are joined together by the continuous joined section 50, thereby sealing space between the separators 31 and 32 surrounded by the joined section 50. The joined section 50 runs continuously along the outer periphery of the joining separator 30.

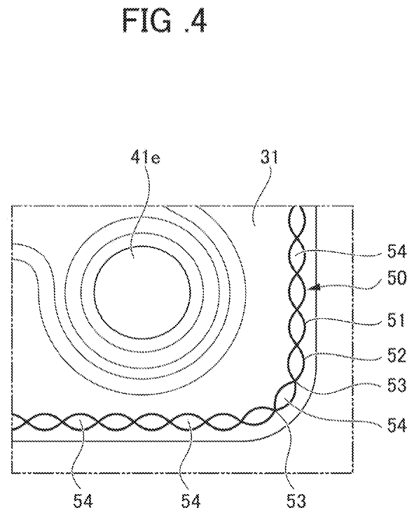

As shown in FIG. 4, the joined section 50 includes: two continuous joining lines, that is, first joining line 51 and second joining line 52, which intersect each other plural times; and a plurality of oval spatial area 54 surrounded by two adjacent intersections 53 of the plurality of intersections of the joining lines 51 and 52, and the joining lines 51, 52 that connect the two intersections 53.

The first joining line 51 and the second joining line 52 are formed in a wavy shape so as to intersect each other at an equal wavelength and extend on the outer periphery of the joining separator 30 while intersecting each other at a predetermined interval. The joined section 50 surrounds and seals spaces entirely between the first joining line 51 and the second joining line 52 as well as the respective communication holes 41a-41e of the above described first communication hole group 41 and the communication holes 42a-42e of the second communication hole group 42.

The length (length along a direction in which the joined section 50 extends) and width of each of the plurality of spatial areas 54 formed by the first joining line 51 and the second joining line 52 are arbitrary. However, an exemplary length is 0.5 to 5.0 mm and an exemplary width is 0.5 to 2.0 mm. Further, although the quantity of the spatial areas 54 is also arbitrary. However, an exemplary number of the spatial areas is 100 to several hundreds.

According to the present embodiment, the first joining line 51 and the second joining line 52 are of laser weld beads formed continuously by laser welding. In the meantime, the joining line is not restricted to a laser weld bead, but may be a weld bead formed by a technique other than the laser welding, for example, TIG welding, MIG welding, seam welding, and may be a joined section formed by friction stir welding, brazing, adhesive, sealant or the like.

The power generation cell 10 having the structure described above according to the embodiment operates as follows. Oxidant gas (e.g., air) is supplied through a communication hole set as an oxidant gas intake communication hole from the communication holes 41a-41e in the first communication hole group 41 and the communication holes 42a-42e in the second communication hole group 42, and the oxidant gas flows through the oxidant gas flow channel 11. Consequently, oxidant gas is supplied to the cathode electrode 22.

Gas containing hydrogen gas is supplied as fuel gas through a communication hole set as a fuel gas intake communication hole from the communication holes 41a-41e in the first communication hole group 41 and the communication holes 42a-42e in the second communication hole group 42, and the fuel gas flows through the fuel gas flow channel 12. Consequently, fuel gas is supplied to the anode electrode 23.

Refrigerant (e.g., pure water, ethylene glycol, oil) is supplied through a communication hole set as a refrigerant intake communication hole from the communication holes 41a-41e in the first communication hole group 41 and the communication holes 42a-42e in the second communication hole group 42, and the refrigerant flows through the refrigerant flow channel 13.

In the membrane electrode assembly 20, electrochemical reaction between the oxidant gas supplied to the cathode electrode 22 and the fuel gas supplied to the anode electrode 23 progresses to generate power. The membrane electrode assembly 20 heated by heat caused by power generation is cooled by refrigerant flowing through the refrigerant flow channel 13.

After being supplied to the cathode electrode 22 and consumed there, oxidant gas flows through the oxidant flow channel 11 to a predetermined oxidant outlet communication hole, where the gas is discharged. At the same time, after being supplied to the anode electrode 23 and consumed there, fuel gas flows through the fuel flow channel 12 to a predetermined fuel outlet communication hole, where the gas is discharged. After flowing through the refrigerant flow channel 13, refrigerant flows to the refrigerant outlet communication hole, where the refrigerant is discharged.

The present embodiment, described above achieves the following advantages. In the joining separator 30 that constitutes the power generation cell 10 of the fuel cell, the joint structure according to the present embodiment joins together the outer peripheries of the first separator 31 and the second separator 32, and includes the continuous joined section 50 that joins together a pair of the layered first separator 31 and the second separator 32 so as to seal a space between the pair of the thin plates surrounded by the joined section 50. The joined section 50 includes: the continuous first joining line 51 and second joining line 52 which intersect each other plural times; and a plurality of spatial areas 54 surrounded by two adjacent intersections of the first junction line 51 and second junction line 53 and the junction lines 51, 52 connecting the two intersections 53.

As a result, the plurality of spatial areas 54 have a structure sealed by the joining lines 51, 52 on the outer periphery and inner periphery. Thus, no leakage occurs in the entire range of the joined section 50 unless a joining failure occurs in both the joining lines 51, 52 on the inner periphery and outer periphery which form a single spatial area 54. Thus, the probability of leakage from the joined section 50 of the joining separator 30 may be reduced compared to the prior art.

According to the present embodiment, the two joining lines, e.g., the first joining line 51 and the second joining line 52, extend while intersecting at a predetermined interval.

Consequently, the plurality of spatial areas 54 may be formed easily and securely with the two joining lines which are the first joining line 51 and the second joining line 52.

According to the present embodiment, the first joining line 51 and the second joining line 52 are formed in a wavy shape.

As a result, when forming the first joining line 51 and the second joining line 52, for example, with laser welding bead, laser scanning may be carried out smoothly and quickly because the lines 51, 52 are not complicatedly curved lines. Thus, the plurality of spatial areas 54 may be formed easily and securely.

According to the present embodiment, the joined section 50 is provided on the outer peripheries of the first separator 31 and the second separator 32 of a pair of thin plates.

Consequently, according to the present embodiment, the probability of leakage may decrease as described above. Thus, the leakage may be suppressed effectively by applying the embodiment to the joined section 50 on the outer periphery.

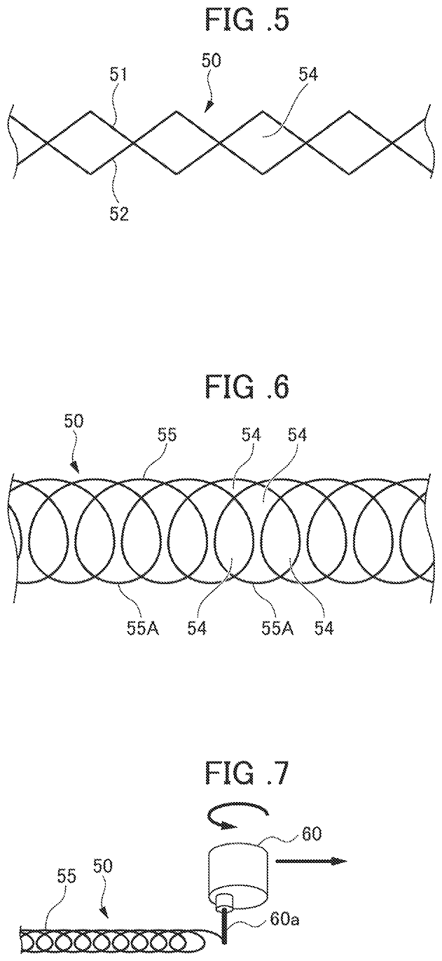

FIG. 5 and FIG. 6 show modifications of the joined section 50. In the joined section 50 shown in FIG. 5, the first joining line 51 and the second joining line 52 extend in a zigzag shape. Each spatial area 54 between two adjacent intersections 53 is rectangular (diamond).

In the joined section 50 shown in FIG. 6, a single joining line 55 extends with a plurality of circular loops 55A which overlap each other. In this case, the adjacent loops 55A intersect each other so as to form a plurality of spatial area 54 in a single loop 55A. The joined section 50 shown in FIG. 6 enables more spatial areas 54 to be formed with a single joining line 55 effectively.

FIG. 7 shows a situation of forming the single joining line 55 shown in FIG. 6 with laser 60a from a laser welder 60. In the case where the joining line 55 is single, for example, running the laser welder 60 while rotating the laser welder 60 enables the joined section 50 to be formed effectively by making one lap around on the outer periphery. In this case, the joining separator 30 may be rotated; or the laser welder 60 and the joining separator 30 may be rotated relative to each other.

In the meantime, the shape of the spatial area is not restricted to oval, circular, rectangular or the like, but may be in various shapes. Further, the joining line in a range between its intersections may be a combination of linear lines as shown in FIG. 5, circular, wavy, zigzag or the like.

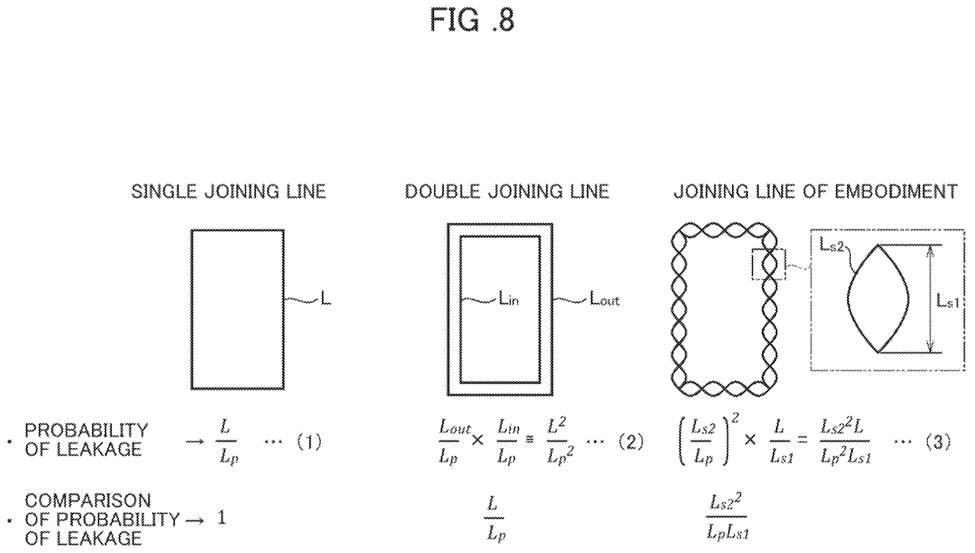

Next, the advantage of the present invention will be verified as compared to the prior art with reference to FIG. 8. In the case of forming continuous joining lines with a laser welder along the outer periphery of a rectangular joining separator having a simple shape, FIG. 8 shows expressions (1), (2) and (3) for calculating a probability of leakage in: a case where the joining line is “single joining line” as a single linear line; a case where the joining line is “double joining line” as two parallel linear joining lines; and a case of the “joining line of the embodiment” as double wavy line continuously intersecting each other as described above in the embodiment.

FIG. 8 assumes that the probability of leakage due to a joining failure, e.g., a break of the joining line is a single location per a total length Lp(m) of the joining line, that is, that the leakage occurs at a probability of 1/Lp. For example, in the case where Lp is 15 m, if the total length of the joining line of the “single joining line” of the prior art is L, the probability of leakage occurrence may be calculated from the expression (1): L/Lp in FIG. 8. For example, if L is 3 m, the probability of leakage occurrence is 3/15, that is, 20%.

Assuming the length of the joining line inside is Lᵢₙ and the length of the joining line outside is Lₒᵤₜ in the case of the “double joining line” of the prior art, the probability of leakage occurrence may be calculated according to the expression (2) in FIG. 8, that is, almost L²/Lp².

In contrast, in the case of the joining line according to the above-described embodiment, the probability of leakage occurrence may be calculated according to the expression (3) in FIG. 8, that is, almost Lₛ₂²L/Lp²Lₛ₁.

Here, the three types of the joining lines shown in FIG. 8 will be compared. Assuming the probability of leakage occurrence (20%) in the case of the “single joining line” of the prior art is 1, the probability in the case of the “double joining line” is L/Lp and the probability of case of the “joining line of the embodiment” is Lₛ₂²/LpLₛ₁.

Each probability indicated by the expressions (1) to (3) in FIG. 8 will be described with reference to actual values. Assume that a line indicated by L, which is “single joining line”, is a basic line to be joined together and the L is 3 m. Further, assume that Lp is 15 m as described above. Then, in the case of “single joining line”, the probability of leakage occurrence is 20% according to the expression (1), as described above.

In the case of “double joining line”, assume that the joining line Lᵢₙ inside is formed inside the joining line L and the joining line Lₒᵤₜ outside is formed outside the joining line L. Assuming that the joining line Lᵢₙ inside is 2.9 m and the joining line Lₒᵤₜ outside is 3.1 m, the probability of leakage occurrence is 4% according to the expression (2).

In the case of the “joining line of the embodiment”, assume that the length of a spatial area Lₛ₁ is 1 mm and the length of the joining line Lₛ₂ is 1.4 mm, the probability of leakage occurrence is 0.0026% according to the expression (3).

Thus, the joined section having the plurality of oval spatial areas 54 formed by intersection of the first joining line 51 and the second joining line 52 according to the present embodiment enables probability of leakage occurrence to decrease to approximately 1/10,000 with respect to the simple single joining line. The reason is that leakage occurs only when a pair of the joining lines inside and outside which constitute a single spatial area 54 of the plurality of minute spatial areas experience joining failures. That is, probability that a pair of the joining lines experience such a joining failure at the same time is extremely low.

The present invention is not restricted to the above-described embodiment, but may be modified or improved appropriately within a scope of the invention. The present invention may be applied to not only a separator for a fuel cell but also other components having an inside structure sealed by joining a pair of thin plates.

### EXPLANATION OF REFERENCE NUMERALS

20 membrane electrode assembly
30 joining separator (fuel cell separator)
31 first separator (thin plate)
32 second separator (thin plate)
50 joined section
51 first joining line (joining line)
52 second joining line (joining line)
53 intersection
54 spatial area
55 joining line
55A loop

What is claimed is:

1. A joint structure comprising a continuous joined section that joins together a pair of thin plates layered on each other so as to seal a space between said pair of the thin plates, said space surrounded by said joined section,
wherein said joined section includes at least one continuous joining line that intersects plural times, and
a plurality of spatial areas surrounded by two adjacent intersections of said joining line and said joining line connecting the two intersections.

2. The joint structure according to claim 1, wherein two of said joining line extend while intersecting each other at a predetermined interval.

3. The joint structure according to claim 2, wherein said joining line is formed in a wavy shape.

4. The joint structure according to claim 1, wherein one of said joining line extends with a plurality of loops formed by overlapping.

5. The joint structure according to claim 1, wherein said joined section is provided on an outer periphery of said pair of the thin plates.

6. The joint structure according to claim 2, wherein said joined section is provided on an outer periphery of said pair of the thin plates.

7. The joint structure according to claim 3, wherein said joined section is provided on an outer periphery of said pair of the thin plates.

8. The joint structure according to claim 4, wherein said joined section is provided on an outer periphery of said pair of the thin plates.

9. A fuel cell separator that is layered onto a membrane electrode assembly,
said fuel cell separator comprising a first separator of a thin plate, and
a second separator of a thin plate to be layered onto said first separator and joined together,
said first separator and said second separator being joined together by the joint structure according to claim 1.
